(19) United States
(12) Patent Application Publication
(10) Pub. No.: US 2016/0347494 A1
(43) Pub. Date: Dec. 1, 2016

(54) COMPOSTABLE PREFORM

(71) Applicant: William Horner, Red Oaks, IA (US)

(72) Inventor: William Horner, Red Oaks, IA (US)

(21) Appl. No.: 15/165,316

(22) Filed: May 26, 2016

Related U.S. Application Data
(60) Provisional application No. 62/166,769, filed on May 27, 2015.

(51) Int. Cl. B65D 1/02; B29B 11/08

(52) U.S. Cl. CPC B65D 1/0207; B29B 11/08; B65D 1/0246; B29K 2067/046

(57) ABSTRACT

An injection molded preform is presented. The injection molded perform includes a body, the body having a finish portion, a transition portion in mechanical communication with the finish portion, a body portion in mechanical communication with the transition portion, and a closed end cap portion in mechanical communication with the body portion. The finish portion, the transition portion, the body portion and the end cap portion define a space therein. The body is used for making a blow molded biodegradable bioresin bottle having a substantially circular cross-section. The preform comprises a blend of polylactic acid or polylactide and other compostable materials.

### CROSS REFERENCE TO RELATED APPLICATIONS

The present application claims the benefit of U.S. Provisional Patent Application No. 62/166,769 filed on May 27, 2015, which is incorporated herein by reference in its entirety.

### BACKGROUND

A preform is used to provide a bottle. A blow molding process is used to convert the preform into a bottle. This process has two main different methods, namely a single-stage process and a two-stage process. A preform is provided using an injection molding process. These preforms are produced with the necks of the bottles, including threads (the “finish”) on one end. These preforms are packaged, and fed later (after cooling) into a reheat stretch blow molding machine. The preforms are heated (typically using infrared heaters) above their glass transition temperature, then blown using high-pressure air into bottles using metal blow molds. In the single-stage process both preform manufacture and bottle blowing are performed in the same machine. In the two-stage process the preforms are produced and then are used at a later time to produce bottles.

Virtually all “single-serve” or “convenience-size” beverage bottles sold in the United States are made from polyethylene terephthalate (“PET”). PET has become the material of choice for bottled beverages because, among other reasons, of its lightweight and shatter resistance and because PET bottle manufacturing techniques are widely known.

In light of the significant disadvantages associated with PET beverage containers, attention has been given in recent years to the possibility of creating acceptable beverage containers from resins made from renewable, plant-based materials, with the additional benefit of being biodegradable. One such biodegradable bioresin is polylactic acid or polylactide (“PLA”). PLA is a biodegradable, thermoplastic, aliphatic polyester that is derived from renewable resources, such as corn starch or sugarcanes, and thus is not a petroleum-based product. PLA provides several different landfill waste diversion options as compared to PET because PLA can be physically recycled, industrially composted, incinerated or chemically converted back to lactic acid through hydrolysis. In addition PLA is 100% recyclable and can be recycled into virgin PLA and then used to make PLA bottles without the need to add additional non-recycled PLA.

Composting of plastic articles provides an environmentally friendly method of disposal where the product is made from a compostable plastic. One of the largest volume products being made from conventional plastic at this time is the container closure in various volume configurations. The container closure is typically used on bottles of water, soft drinks, and other fluids.

### SUMMARY

Conventional mechanisms such as those explained above suffer from a variety of deficiencies. One such deficiency is that conventional bottles made from performs is not compostable. For an item to be marked compostable, there must be scientific evidence that the materials in the item break down, or become part of, usable compost in a safe and timely manner in an appropriate composting facility or home compost pile.

There are four specific criteria for a material to be labeled compostable. First, it must biodegrade—at least 90% carbon content must go away within 90-180 days. Second, it must disintegrate—at least 90% of the material must disintegrate within 84 days. Third, it must not contain heavy metals above concentrations defined by North America or EU restrictions. Fourth, the disintegrated content must support future plant growth as humus. These four conditions are tested per the ASTM D6400 standard.

The present invention relates to a bottle made from a biodegradable bioresin and in particular to a renewable biodegradable bioresin bottle made from plants, not crude oil, comprising polylactic acid or polylactide and other compostable materials.

Note that each of the different features, techniques, configurations, etc. discussed in this disclosure can be executed independently or in combination. Accordingly, the present invention can be embodied and viewed in many different ways. Also, note that this summary section herein does not specify every embodiment and/or incrementally novel aspect of the present disclosure or claimed invention. Instead, this summary only provides a preliminary discussion of different embodiments and corresponding points of novelty over conventional techniques. For additional details, elements, and/or possible perspectives (permutations) of the invention, the reader is directed to the Detailed Description section and corresponding figures of the present disclosure as further discussed below. All examples and features mentioned below can be combined in any technically possible way.

### BRIEF DESCRIPTION OF THE DRAWINGS

The foregoing will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 comprises a view of a bio-degradable compostable preform in accordance with embodiments of the invention.

### DETAILED DESCRIPTION

The embodiments set forth below represent the necessary information to enable those skilled in the art to practice the invention and illustrate the best mode of practicing embodiments of the invention. Upon reading the following description in light of the accompanying figures, those skilled in the art will understand the concepts of the invention and recognize applications of these concepts not particularly addressed herein. It should be understood that these concepts and applications fall within the scope of the disclosure and the accompanying claims.

The preferred embodiment of the invention will now be described with reference to the accompanying drawings. The invention may, however, be embodied in many different forms and should not be construed as limited to the embodiment set forth herein; rather, this embodiment is provided so that this disclosure will be thorough and complete, and will fully convey the scope of the invention to those skilled in the art. The terminology used in the detailed description of the particular embodiment illustrated in the accompanying drawings is not intended to be limiting of the invention. In the drawings, like numbers refer to like elements.

A biodegradable material is a material that can be broken down into carbon dioxide (CO₂) and water (H₂O) by microorganisms such as bacteria and fungi. Such materials undergo a significant change in chemical structure during this process, resulting in loss of properties including, but not limited to, molecular weight, structure, strength, and integrity. A compostable material is a biodegradable material that satisfies one or more of the various standards regarding biodegradability, such as rate biodegradation, maximum residue of material left at a specific point in time and a requirement for the material to have no harmful impact on the final compost or the composting process. Commonly used standards for compostable plastic materials are the American standard ASTM D 6400-99, the European standard EN-13432 and DIN V-54900. As set forth in ASTM D 6400-99, such a material is “capable of undergoing biological decomposition in a compost site as part of an available program, such that the plastic is not visually distinguishable and breaks down to carbon dioxide, water, inorganic compounds, and biomass, at a rate consistent with known compostable materials (e.g. cellulose) and leaves no toxic residue.” In accordance with the present invention, a biodegradable and compostable bottle may be created using bioresin material.

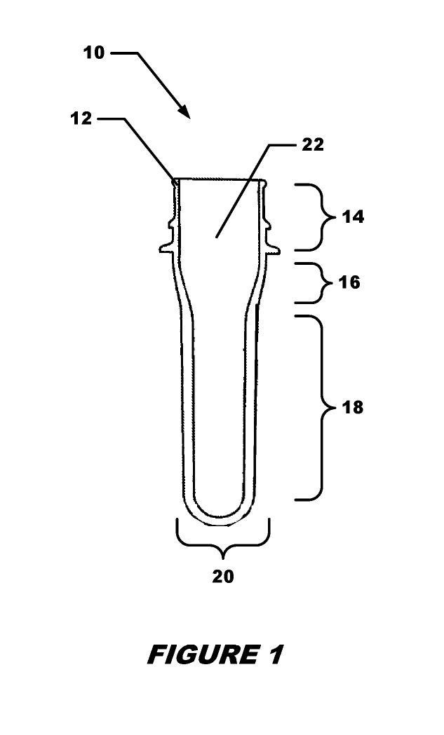

Referring to FIG. 1, the biodegradable compostable container preform 10 is shown. The preform 10 includes a body 12, the body 12 having a finish portion 14, a transition portion 16 in mechanical communication with the finish portion 14, a body portion 18 in mechanical communication with the transition portion 16, and a closed end cap portion 20 in mechanical communication with the body portion. The finish portion 14, the transition portion 16, the body portion 18 and the end cap portion define a space 22 therein. The3 preform 10 is used for making a blow molded biodegradable bioresin bottle having a substantially circular cross-section. The preform comprises a blend of polylactic acid or polylactide and other compostable materials.

The finish portion 14 of injected molded preform 10 has a first outside diameter. The body portion 18 of injected molded preform 10 has a second outside diameter. The transition portion of the injected molded preform has a first end having an outside diameter equal to the first outside diameter and further includes a second end having an outside diameter equal to the second outside diameter. The first outside diameter is greater than the second outside diameter.

The finish portion 14 of injected molded preform 10 has a first inside diameter. The body portion 18 of injected molded preform 10 has a second inside diameter. The transition portion of the injected molded preform has a first end having an inside diameter equal to the first inside diameter and further includes a second end having an inside diameter equal to the second inside diameter. The first inside diameter is greater than the second inside diameter.

The finish portion 14 of injected molded preform 10 has a first sidewall thickness. The body portion 18 of injected molded preform 10 has a second sidewall thickness. The transition portion of the injected molded preform has a first end having sidewall thickness equal to the first sidewall thickness and further includes a second end having an sidewall thickness equal to the second sidewall thickness. The first sidewall thickness is less than the second sidewall thickness.

The injection molded preform 10 is used for making a biodegradable resin bottle for a non-carbonated beverage. In a particular embodiment the non-carbonated beverage is water.

Throughout the entirety of the present disclosure, use of the articles “a” or “an” to modify a noun may be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

Having described preferred embodiments of the invention it will now become apparent to those of ordinary skill in the art that other embodiments incorporating these concepts may be used. Accordingly, it is submitted that that the invention should not be limited to the described embodiments but rather should be limited only by the spirit and scope of the appended claims.

What is claimed is:

1. An injection molded preform comprising:
a body, said body having a finish portion, a transition portion in mechanical communication with said finish portion, a body portion in mechanical communication with said transition portion, and a closed end cap portion in mechanical communication with said body portion;
wherein said finish portion, said transition portion, said body portion and said end cap portion define a space therein;
said body for making a blow molded biodegradable bioresin bottle having a substantially circular cross-section; and
wherein the preform comprises a blend of polylactic acid or polylactide and other compostable materials.

2. The injected molded preform of claim 1 wherein said finish portion has a first outside diameter.

3. The injected molded preform of claim 2 wherein said body portion has a second outside diameter.

4. The injected molded preform of claim 3 wherein said transition portion has a first end having an outside diameter equal to said first outside diameter and wherein said transition portion has a second end having an outside diameter equal to the second outside diameter.

5. The injected molded preform of claim 3 wherein said first diameter is greater than said second diameter.

6. The injected molded preform of claim 1 wherein said finish portion has a first inside diameter.

7. The injected molded preform of claim 6 wherein said body portion has a second inside diameter.

8. The injected molded preform of claim 7 wherein said transition portion has a first end having an inside diameter equal to said first inside diameter and wherein said transition portion has a second end having an inside diameter equal to the second inside diameter.

9. The injected molded preform of claim 8 wherein said first inside diameter is greater than said second inside diameter.

10. The injected molded preform of claim 1 wherein said finish portion has a first sidewall thickness.

11. The injected molded preform of claim 10 wherein said body portion has a second sidewall thickness.

12. The injected molded preform of claim 11 wherein said transition portion has a first end having a sidewall thickness equal to said first sidewall thickness and wherein said transition portion has a second end having a sidewall thickness equal to the second sidewall thickness.

13. The injected molded preform of claim 8 wherein said first sidewall thickness is less than said second sidewall thickness.

14. The injection molded preform of claim 1, wherein the preform is used for making a biodegradable resin bottle for a non-carbonated beverage.

15. The injected molded preform of claim 14, wherein the non-carbonated beverage is water.
